(19) United States
(12) Patent Application Publication
(10) Pub. No.: US 2002/0114481 A1
(43) Pub. Date: Aug. 22, 2002

(54) Speaker apparatus

(75) Inventor: Takuma Watanabe, Nakamura-ku (JP)

Correspondence Address: BURR & BROWN, PO BOX 7068, SYRACUSE, NY, 13261-7068, US

(73) Assignee: DAIWA MARK CO., LTD., Nakamura-ku (JP)

(21) Appl. No.: 10/079,299

(22) Filed: Feb. 20, 2002

(30) Foreign Application Priority Data
Feb. 21, 2001 (JP) 2001-45624

(51) Int. Cl. H04R 1/02; H04R 9/06

(52) U.S. Cl. 381/334; 381/336

(57) ABSTRACT

Provided is a speaker apparatus which is optimal for an acoustic musical instrument. The speaker apparatus comprises an enclosure formed of a body of a classical guitar, and a speaker unit incorporated in the enclosure. Thus, the speaker apparatus reproduces a real tone by making the best use of resonance of the body.

### BACKGROUND OF THE INVENTION

1. Field of the Invention

The invention relates to a speaker apparatus which is suitably available for use in an acoustic musical instrument.

2. Description of the Related Art

When a speaker unit adapted to vibrate its cone paper so as to produce a sound is caused to sound by itself, the sound does not echo and is far from a natural sound. However, when the speaker unit is fixed on a baffle (plate) or is incorporated in an enclosure, this arrangement adds a resonance effect to a sound and thus brings the sound close to a real tone.

Therefore, a typical speaker apparatus is an enclosed type speaker apparatus having a speaker unit incorporated in a strongly built enclosure. The enclosure has a plate thickness great enough to prevent the enclosure from resonating, and moreover, the speaker unit is controlled so as to have uniform frequency characteristics over ranges from low tones to high tones.

Even a speaker apparatus that is said to be an excellent apparatus having excellent reproducibility produces only an artificial sound.

Therefore, a conventional speaker apparatus devotes itself to bringing an artificial sound as close to a sound source as possible, and the speaker apparatus is variously devised so as to try to make corrections by use of an equalizer or so as to have a combination of speaker units having different characteristics. However, the speaker apparatus is limited of itself because the speaker apparatus is adapted to temporarily convert a sound into an electric signal and then reproduce the electric signal by means of a different apparatus from the sound source.

### SUMMARY OF THE INVENTION

The invention provides a speaker apparatus having superior reproducibility for a tone of an acoustic musical instrument, in particular. The speaker apparatus comprises an enclosure which is made of the same material as a material of a body of an acoustic musical instrument and has the same shape as a shape of the body of the acoustic musical instrument, and a vibration generating source which is incorporated in the enclosure and is operated by an electric signal.

A speaker unit may be adopted as the vibration generating source and have cone paper located in non-contact with the enclosure, or an electromagnetic vibrator unit may be adopted as the vibration generating source and have a diaphragm located in close contact with the enclosure.

### BRIEF DESCRIPTION OF THE DRAWINGS

FIG. 1 is an illustration of a speaker apparatus according to the invention;

FIG. 2 is an illustration showing an example of the use of the speaker apparatus;

FIG. 3 is an illustration of a modified embodiment; and

FIG. 4 is an illustration of an electromagnetic vibrator unit.

### DETAILED DESCRIPTION OF THE PREFERRED EMBODIMENTS

Embodiments of a speaker apparatus according to the invention will be described with reference to the drawings.

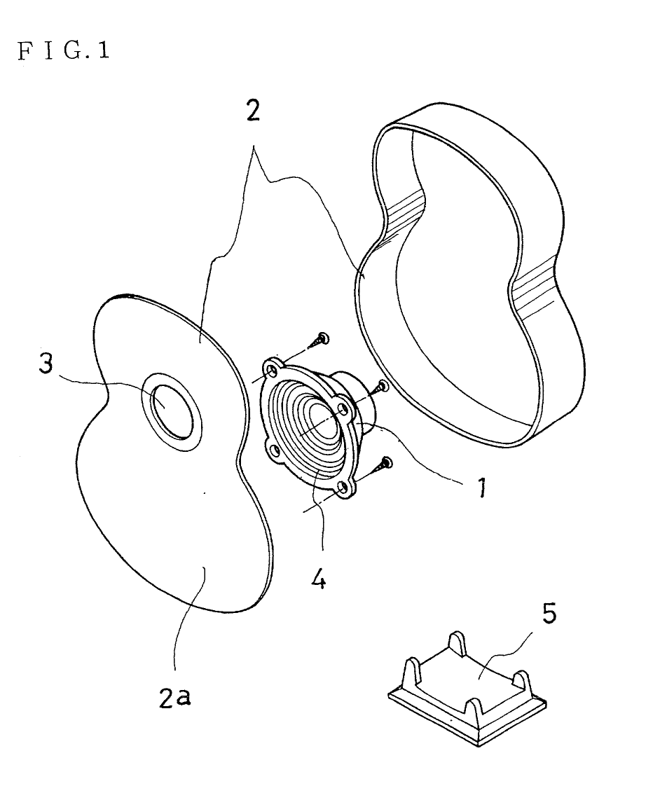

In FIG. 1, numeral 1 denotes a full-range speaker unit (hereinafter referred to as a speaker unit) for functioning as a vibration generating source, and numeral 2 denotes an enclosure. A body of a classical guitar is used as the enclosure 2 as it is.

The enclosure 2 is configured in the following manner: that is, a sound hole 3 that is essential for the body of the guitar is kept open, but a neck is not attached to a neck attaching portion, and the neck attaching portion to which the neck should be originally attached is surface-coated after enclosing.

The speaker unit 1 is incorporated in the enclosure 2, and the speaker unit 1 is screwed on a rear surface of a sound board 2a in such a manner that cone paper 4 is not in contact with the enclosure 2.

In FIG. 1, numeral 5 denotes a support pedestal for supporting the speaker unit 1 in a vertical position with stability.

The speaker apparatus formed as described above operates in the following manner: for example, on the stage during a solo performance, the speaker apparatus picks up a sound of a played guitar through the use of a pickup (not shown) set in a classical guitar 6, converts the sound into an electric signal, and inputs to the speaker unit 1 the electric signal amplified by an amplifier 7, thereby operating the speaker unit 1, which then vibrates the cone paper 4 and thus emits a sound.

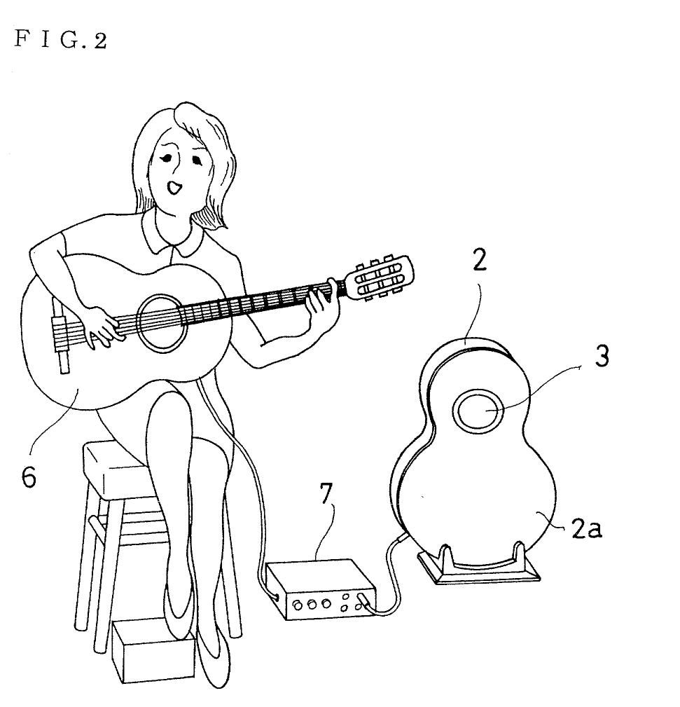

Then, a sound pressure of the sound causes the sound board 2a to vibrate, and this vibration adds a real sound emitted from the whole enclosure 2 to the sound emitted from the speaker unit 1 in itself and thus makes the sound realer, so that this enables a high-volume-level powerful sound of the classical guitar 6 to echo from the sound hole 3 (see FIG. 2).

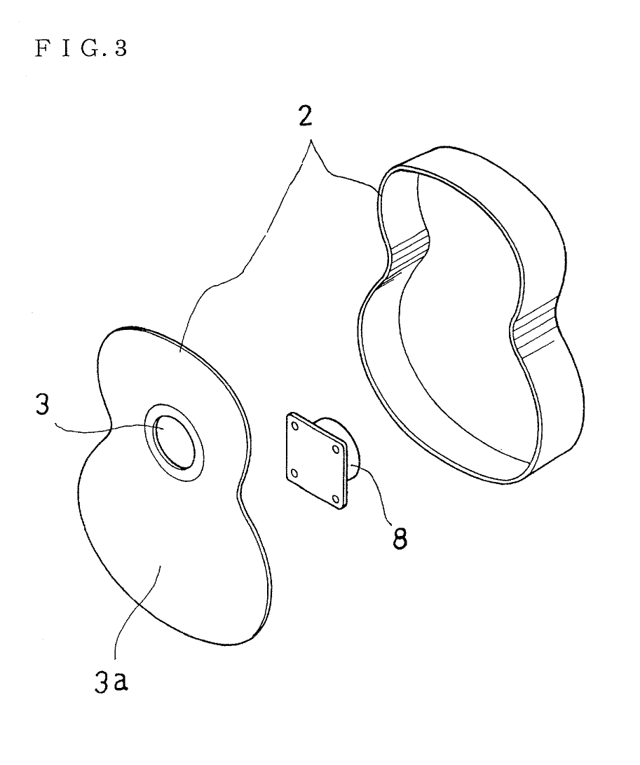

In the above-described embodiment, the speaker unit is adopted as the vibration generating source, but the speaker unit may be replaced by an electromagnetic vibrator unit 8 as illustrated in FIG. 3.

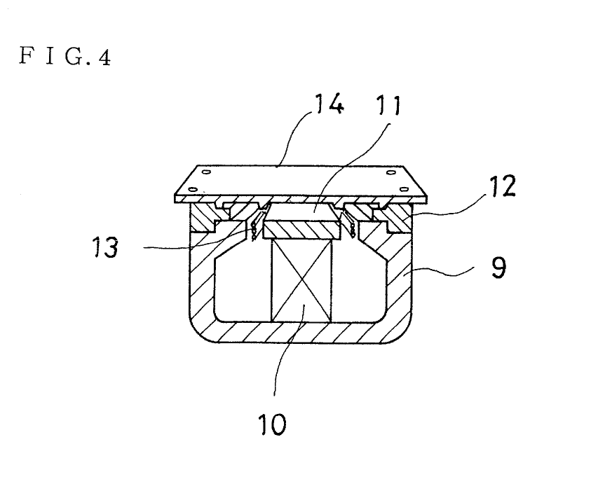

For example, Econic sound transducer WA3020 commercially available from Ale acoustic Co., Ltd. can be preferably adopted as the electromagnetic vibrator unit 8. As shown in FIG. 4, the electromagnetic vibrator unit 8 comprises a yoke 9, a magnet 10, a ball piece 11, packing 12, a voice coil 13, a diaphragm 14 and so on, and the diaphragm 14 is screwed on the rear surface of the sound board 2a in such a manner that the diaphragm 14 is in close contact with the rear surface.

Since a sound emitted from a speaker apparatus of this embodiment is composed of only a sound produced by vibration of the sound board, the sound is acceptable as the very tone of the guitar.

The speaker apparatus is, of course, used for the solo performance as in the case of the above-described embodiment, and moreover, the speaker apparatus reproduces a real tone when a signal temporarily recorded on a tape or a disk is reproduced.

In particular, when the speaker unit is used as the vibration generating source, the speaker apparatus is also superior in reproducibility for sounds other than the sound of the classical guitar, and therefore the speaker apparatus is suitable for a performance with a vocal performance or other musical instruments. When the electromagnetic vibrator unit is used as the vibration generating source, even a grating noise is mixed in with sounds of a musical instrument produced by vibration of the sound board, so that the noise hardly feels grating.

In the embodiments, the description is given with regard to the application to the classical guitar. However, the speaker apparatus of the invention maybe applied to any type of musical instrument, to say nothing of a guitar designed for folk music and an acoustic guitar, as long as the musical instrument is an acoustic musical instrument, such as a piano S. Accordingly, the speaker apparatus of the invention exerts the best effect in appropriate combination with a musical instrument to be played.

In the above-described embodiments, the enclosure does not have the neck, but it can be expected that the attachment of the neck, strings and the like achieve the effect of improving visual reality.

The speaker apparatus of the invention has the enclosure which is made of the same material as a material of a body of an acoustic musical instrument and has the same shape as a shape of the body thereof, and therefore the effective use of a phenomenon of resonance of the enclosure allows reproducing a real tone emitted from the acoustic musical instrument in itself.

When the speaker unit is used as the vibration generating source, the speaker apparatus of the invention is suited to allow the sound of the acoustic musical instrument to stand out against sounds of musical instruments played with the acoustic musical instrument without sacrificing the sounds of the musical instruments played therewith. When the electromagnetic vibrator unit is used as the vibration generating source, a noise signal picked up by the pickup is converted into vibration of the sound board, and thus the noise is mixed in with sounds of the musical instrument, so that the noise does not feel grating.

What is claimed is:

1. A speaker apparatus comprising:
an enclosure which is made of the same material as a material of a body of an acoustic musical instrument and has the same shape as a shape of the body of the acoustic musical instrument; and
a vibration generating source which is incorporated in said enclosure and is operated by an electric signal.

2. The speaker apparatus according to claim 1, wherein said vibration generating source is a speaker unit, and the speaker unit has cone paper located in non-contact with said enclosure.

3. The speaker apparatus according to claim 2, wherein said vibration generating source is an electromagnetic vibrator unit, and the electromagnetic vibrator unit has a diaphragm located in close contact with said enclosure.
